(19) United States
(12) Patent Application Publication
(10) Pub. No.: US 2010/0067724 A1
(43) Pub. Date: Mar. 18, 2010

(54) Molded Pull String for Custom Hearing Instruments

(75) Inventor: Salman Parsi, Somerset, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Hearing Instruments, Inc., Piscataway, NJ (US)

(21) Appl. No.: 12/210,353

(22) Filed: Sep. 15, 2008

(51) Int. Cl. H04R 25/00

(52) U.S. Cl. 381/329

(57) ABSTRACT

A pull string for a hearing instrument may be attached to an anchor positioned on the inside wall of the hearing instrument shell. Collision detection may be utilized to determine a location for the anchor and the pull string.

### CROSS-REFERENCE TO RELATED APPLICATIONS

This application is related to U.S. Patent Application Publication No. 2002/0196954 A1, published Dec. 26, 2002, and titled “Modeling and fabrication of three-dimensional irregular surfaces for hearing instruments,” incorporated herein by reference.

### BACKGROUND AND SUMMARY OF THE INVENTION

Currently, pull strings for hearing instruments are made from clear fishing line. A knot is formed at one end of the string or the end is melted back using a soldering iron, to create a mechanical support. This end is then glued to the inside of the hearing instrument shell or to the faceplate.

There are at least two disadvantages to this approach—uncertainty in finding a suitable location for the pull string within the shell and, oftentimes, a less-than optimal utilization of the space within the shell. The foregoing disadvantages can be avoided by locating the pull string within the shell of the hearing instrument using collision detection techniques. Once this location has been determined, an anchor is created on the inside surface of the hearing instrument shell. The pull string is fabricated as a molded element with a fixed end that cooperatively engages the anchor, and its free end is routed through an opening in the faceplate of the hearing instrument.

### BRIEF DESCRIPTION OF THE DRAWINGS

FIG. 1 is a cross-sectional drawing of a hearing instrument shell residing in the ear canal, with a pull string affixed to an anchor inside the shell;

FIGS. 2-14 are drawings of various configurations of the pull string and the anchor of FIG. 1;

FIG. 15 is a cross-sectional drawing of a hearing instrument shell residing in the ear canal, with a pull string affixed to an anchor inside the shell, where the anchor and the pull string are embedded within the wall of the shell;

FIG. 16 is a flow chart of a process for locating the pull string and the anchor within the shell; and

FIG. 17 is a flow chart of a process for attaching the pull string to the hearing instrument shell.

### DESCRIPTION OF THE INVENTION

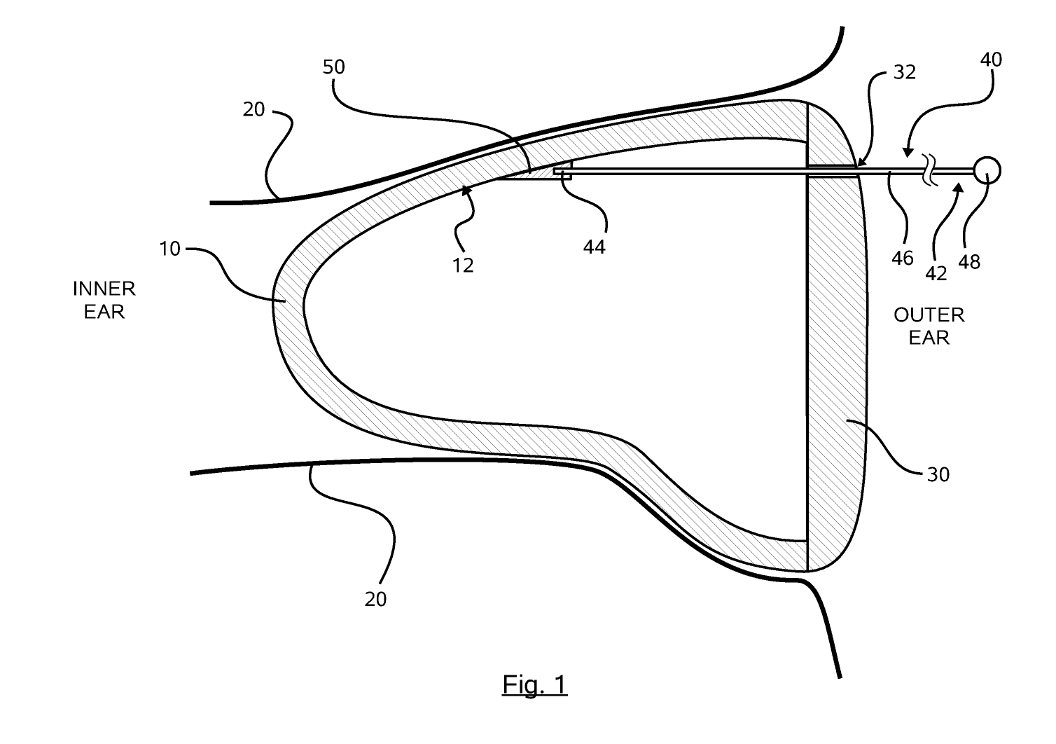

A hearing instrument shell 10 is shown residing in an ear canal 20, between the inner and outer ears, in FIG. 1. The shell 10 has a faceplate 30 attached to the shell at the point closest to the outer ear. A molded pull string 40 is provided to aid in removal of the shell 10 from the ear canal 10. The pull string 40 has a free end 42 located outside the shell 10 and a fixed end 44 attached to an anchor 50 (depicted here schematically) on the inside wall 12 of the shell 10. The shaft 46 of the pull string 40 passes through an opening 32 in the faceplate 30.

Anchor Configurations

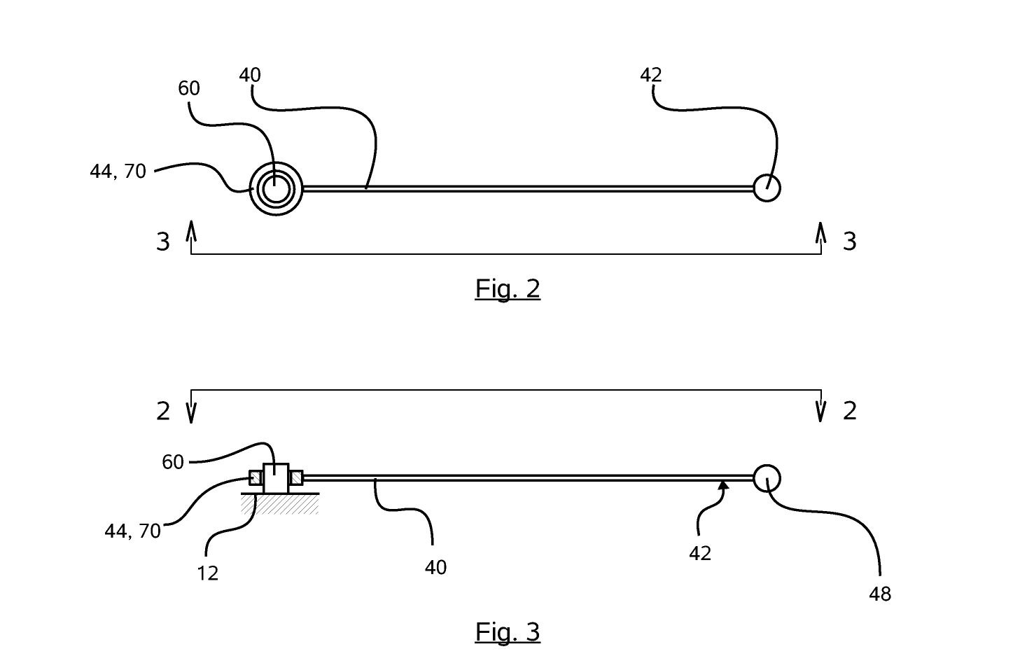

The anchor 50 may assume a number of configurations. For example, in FIG. 2, the anchor is a post 60 and the fixed end 44 of the pull string 40 is an annulus 70 that slips onto the post 60. The post 60 is shown again in the elevation view of FIG. 3, where the annulus 70 is illustrated in partial cross-section. The post 60 may be circular in cross section or have some other shape as desired—square, triangular, etc. If the post 60 has a non-circular cross section, the pull string 40 may be provided with a conforming opening in the fixed end 44.

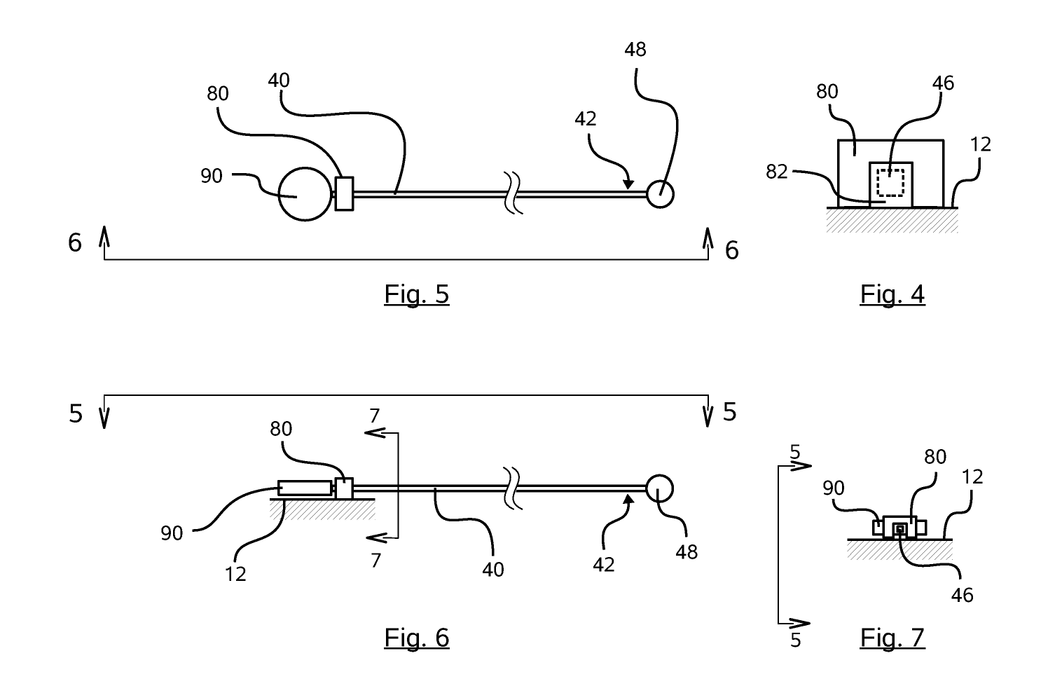

Instead of the post 60 and annulus 70 of FIGS. 2 and 3, the pull string 40 may be secured to the inside shell wall 12 by placing a restraining arch 80 (FIG. 4) over the shaft 46 of the pull string 44 (shown in phantom). The fixed end 44 of the pull string 40 may be configured as a disk 90 or some other shape and size such that it cannot pass through the opening 82 in the arch 80. In lieu of a disk 90, the fixed end 44 of the pull string 40 may be fashioned as a sphere, a polyhedron, a half-disk, or any other suitable shape. The arch 80, together with the pull string 40, is shown in the top, elevation, and partial cross-sectional views of FIGS. 5-7, respectively.

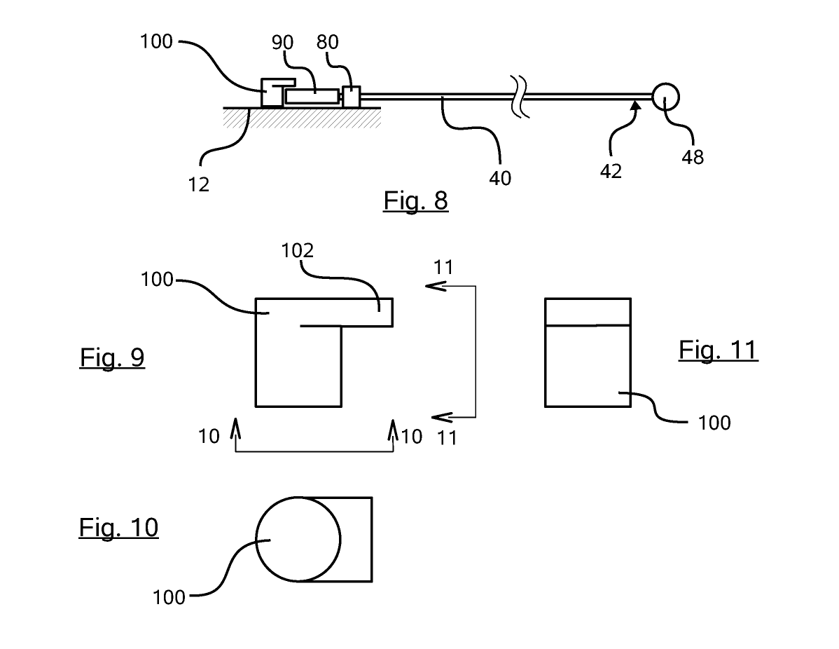

To further secure the fixed end 44 of the pull string 40, a tab and post assembly 100 may be positioned on the shell wall 12 behind the arch 80, as shown in FIGS. 8-11. The tab and post assembly 100 has a 102 tab that lays over the disk 90.

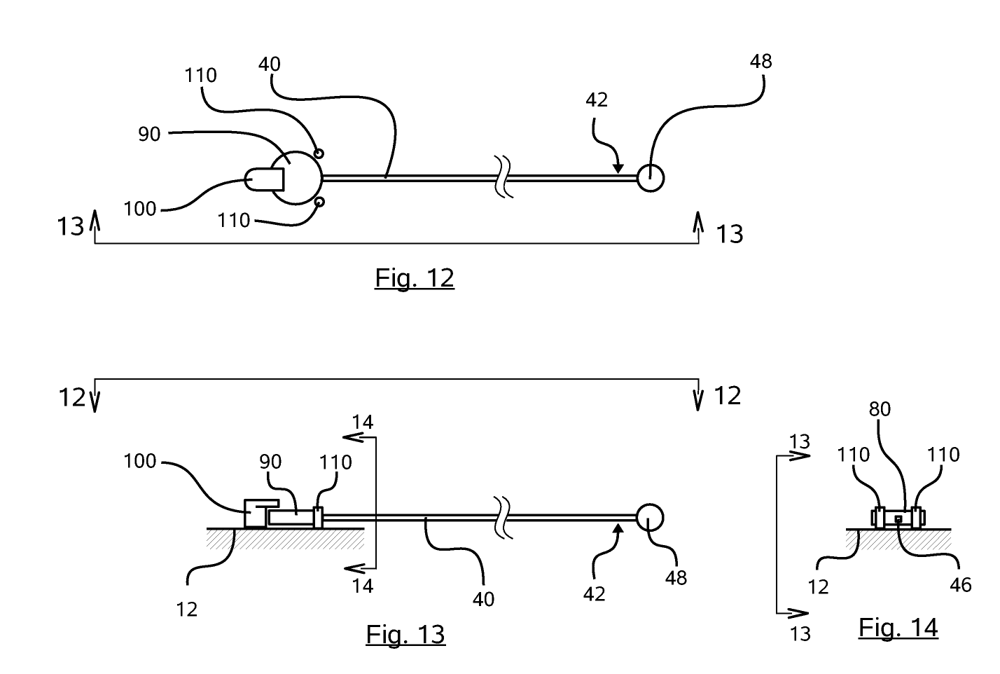

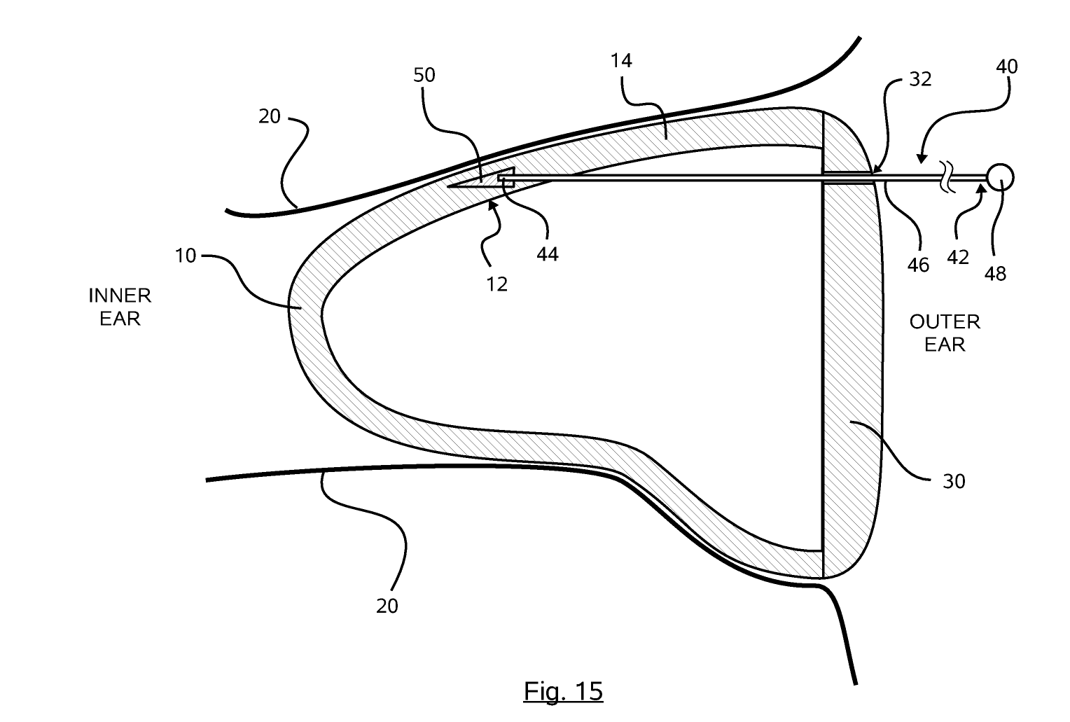

Two posts 110 may be substituted for the arch 80 as illustrated in FIGS. 12-14. The posts 110 may be fashioned as cylinders (as shown in the figures), or may utilize another cross section as desired.

Partially Embedding the Pull String and the Anchor

To further conserve the use of space within the shell and provide structural support for the pull string 40, a portion of the pull string shaft 46 may be embedded within the wall 14 of the shell 10, as shown in FIG. 15. Similarly, the anchor 50 may be fully or partially embedded within the shell wall 14.

Materials

The pull string 40 may be fashioned from a material such as Vydyne 215PF natural nylon in an injection molding process. The material selected should be capable of withstanding a pull force of 15-20 Newtons.

Shell Design and Component Placement

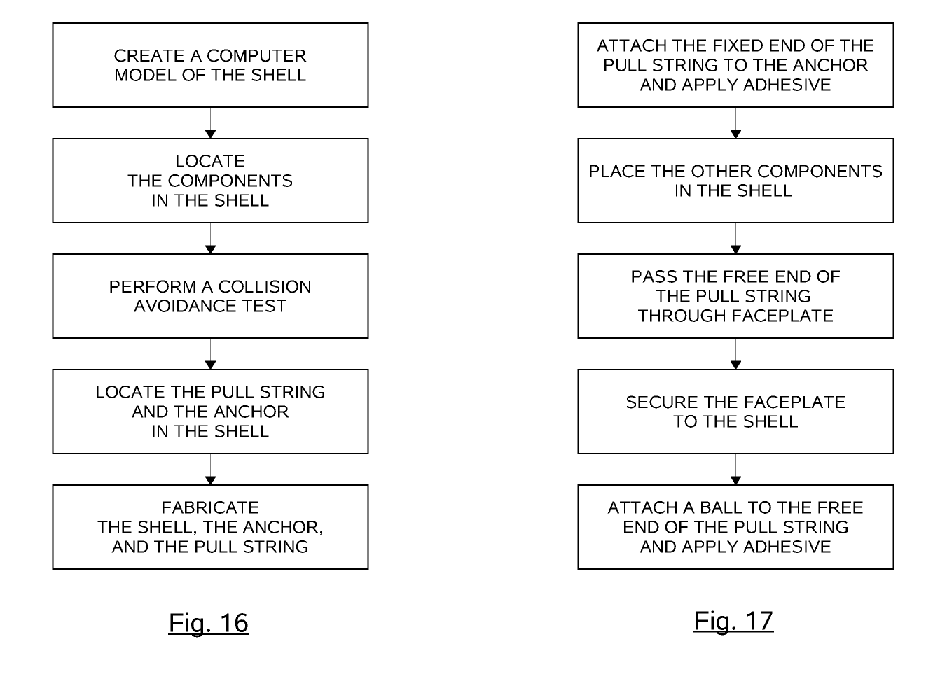

The location of the anchor 50 and the pull string 40 inside the shell 10 may be selected using collision detection methods to avoid conflicts with other components within the shell 10, as indicated in the flow chart of FIG. 16. Initially, a computer model of the hearing instrument shell 10 is created. The components of the hearing instrument are then positioned within the shell model and a collision avoidance test is performed. A location within the shell 10 for the pull string 40 and the anchor 50 can then be chosen. The shell 10, the anchor 50, and the pull string 40 can then be fabricated.

The foregoing process may be used to design the hearing instrument shell 10 of FIG. 15, with the understanding that a portion of the pull string shaft 46 and possibly all or part of the anchor 50 would be embedded within the wall 14 of the shell 10.

Assembly

During assembly, the fixed end 44 of the pull string 40 is attached to the anchor 50, as indicated in the flow chart of FIG. 17. The fixed end 44 may be further secured to the anchor 50 by an adhesive such as a clear paste cured with ultraviolet light.

The free end 42 of the pull string 40 may then be routed through an opening 32 in the faceplate 30, and its length trimmed as desired. To enable the user to securely grasp the free end 42 of the pull string 40, a ball 48 or any other suitable structure may be attached to the free end 42 and secured with an adhesive.

What is claimed is:

1. A hearing instrument shell assembly, comprising:
a hearing instrument shell comprising an inside wall;
a pull string comprising fixed and free ends; and
an anchor secured to the inside wall of the hearing instrument shell that cooperatively engages the fixed end of the pull string.

2. An assembly as set forth in claim 1, where
the fixed end comprises an annulus; and
the anchor comprises a post.

3. An assembly as set forth in claim 1, where
the pull string comprises a shaft between the fixed and the free ends; and
the anchor comprises a restraining arch through which the pull string shaft passes.

4. An assembly as set forth in claim 1, where the anchor comprises vertical posts through which the pull string shaft passes.

5. An assembly as set forth in claim 1, where
the shell comprises a wall;
the pull string comprises a shaft between the fixed and the free ends, and a portion of the shaft is embedded within the wall.

6. An assembly as set forth in claim 5, where the anchor is at least partially embedded within the wall.

7. A method for designing a hearing instrument shell comprising an interior volume and an inside wall, where the shell comprises components positioned within the interior volume and a pull string attached to an anchor on the inside wall of the shell, comprising:
creating a computer model of a hearing instrument shell;
locating the components within the computer model of the shell;
performing a collision avoidance test;
in response to the collision avoidance test, adjusting the location of the components within the computer model of the shell;
locating the pull string within the computer model of the shell; and
locating the anchor on the inside wall of the computer model of the shell.

8. A method as set forth in claim 7, further comprising embedding a portion of the pull string within the wall of the shell.

9. A method as set forth in claim 8, further comprising embedding a portion of the anchor within the inside wall of the computer model of the shell.
